(19) United States
(12) Patent Application Publication
(10) Pub. No.: US 2004/0210506 A1
(43) Pub. Date: Oct. 21, 2004

(54) Systems and methods for directing elective account balances

(75) Inventors: Kenneth Algiene, Littleton, CO (US); Brenda K. McDonald, Coconut Creek, FL (US); David Baumgartner, Parker, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO

(21) Appl. No.: 10/645,722

(22) Filed: Aug. 20, 2003

Related U.S. Application Data
(60) Provisional application No. 60/464,683, filed on Apr. 21, 2003.

(51) Int. Cl. G06F 17/60

(52) U.S. Cl. 705/37

(57) ABSTRACT

Systems and methods for distributing and/or calculating elective account balances. Various of the systems include one or more microprocessor based devices that are coupled to a communication network. A computer readable medium is associated with at least one of the microprocessor based devices, and includes instructions executable by the microprocessor based device to serve interfaces and receive information via the interfaces. In addition, the information received via the interfaces can be used to allocate at least a portion of an elective balance to a redemption category, and to calculate a redemption amount. Various of the methods include receiving one or both of a bid premium and a allocation amount. This information can be used to calculate a redemption amount.

### CROSS-REFERENCES TO RELATED APPLICATIONS

This application claims priority to U.S. Provisional Patent Application Serial No. 60/464,683, filed Apr. 21, 2003, entitled: “SYSTEMS AND METHODS FOR DIRECTING ELECTIVE ACCOUNT BALANCES.” The entirety of the aforementioned Provisional Application is incorporated herein by reference for all purposes.

### FIELD OF THE PRESENT INVENTION

The present invention relates broadly to systems associated with maintaining accounts, and in particular to the allocation and redemption of various incentive accounts.

### BACKGROUND OF THE INVENTION

Employees, as well as others enjoying an association with an entity may from time to time be granted some sort of perk or incentive to continue working, or to recognize an important milestone. Such incentives can include, for example, a pen set or a travel voucher that the recipient may or may not want. In some cases, a recipient may have preferred a cash equivalent of the incentive, or some other incentive.

Further, an open market for bidding on the supply of such incentives typically does not exist. It is often the case that a personnel manager chooses incentive items from a catalog based on a preset budget. Once selected, each recipient receives the same item, or an item selected from a limited set of items. Various recipients have different needs and likes, and thus, such an approach is unlikely to address the needs and desires of each recipient. Further, such an approach is unlikely to maximize the effect of an incentive program, or the benefits received there from.

Hence, for at least the aforementioned reasons, there exists a need in the art for advanced systems and methods for distributing, allocating, and/or redeeming incentives.

### BRIEF SUMMARY OF THE INVENTION

Among other things, the present invention addresses the need in the art for advanced systems and methods for distributing, allocating, and/or redeeming incentives. In particular, the present invention relates to systems and methods for distributing, allocating, and/or redeeming an elective account balance to a variety of redemption categories, based on input received from a holder of the account.

The present invention provides mechanisms for selecting a method, form, and/or amount to distribute from an account balance. The form can be, for example, a stored value card associated with a particular retailer, a cash sum, a piece of merchandise that may either be delivered to a particular location or retrieved from a particular retail outlet, a certificate exchangeable for a particular service, a stock certificate, or the like. Once the form has been selected, the amount of the redemption can be deducted from the account balance, and the redemption can be provided to the account holder, or other beneficiary in the selected form and according to the selected method. Thus, for example, a stored value card can be mailed to a recipient, a piece of merchandise can be delivered to a recipient, a cash amount can be applied to an account of the recipient, or the like.

Some versions of the present invention also provide for granting premiums based on a selected redemption category. In one particular case, various retailers vie for the elective balances maintained by an entity through offering premiums that can be, for example, more than one hundred percent of an account balance, where the account balance is redeemed for a stored value card associated with a particular retailer. In some cases, each of the retailers can see the premiums being offered by other retailers, and decide whether to increase or reduce premiums that they are offering. Thus, particular aspects of the present invention provide an auction like market useful to capture balances associated with elective accounts.

In one particular embodiment of the present invention, a system for distributing elective account balances is provided. The system includes a computer, or other microprocessor based device that is associated with a computer readable medium, and is communicably coupled to a communication network. The computer readable medium includes instructions executable by the computer to receive requests to provide interfaces to one or more bid devices, and one or more redemption devices. The instructions are further executable to serve the various interfaces to the requesting bid and/or redemption devices. The interfaces provided to the redemption devices can include input fields allowing a user to select one or more redemption categories, and allocation amounts associated with the selected redemption categories. Thus, for example, if an account holder wanted to redeem half of an accrued balance with a retailer, and the other in cash, the account holder could select cash and the retailer as redemption categories, and allocate half of the balance to each.

The interfaces provided to the bid devices provide a retail outlet, service provider, or other entity with an ability to enter a premium at which they are willing to redeem an account balance, or a portion thereof. Thus, for example, the aforementioned retailer may want to encourage a user to spend their account balance with the retailer. To do this, the retailer can provide a bid premium to the system via the interface. The bid premium is an amount typically above par that the retailer is willing to offer in the form of, for example, a stored value card in order to capture a portion of the user's account balance.

The system can further take the bid premium and allocation information to calculate various account values. For example, the system can calculate a redemption value and an available balance. The available balance, or elective balance, is an amount available in an elective account associated with a user. Thus, the available balance can be the accrued value in an elective account, less any previous redemption amounts. The redemption value is the value which the user has available to redeem, based on the selected redemption category and percentage of the available balance allocated to the redemption category. Thus, in some cases, the redemption amount is the available balance multiplied by the allocated percentage and the bid premium associated with the particular redemption category. Where a redemption occurs, the amount of the redemption can be deducted from the redemption amount, and the available balance in proper proportion.

The redemption categories can include, but are not limited to cash, a retail outlet, vacation time, additional sick days, a service provider, and the like. Thus, for example, a user may be able to select from a hardware store, a telecommunications service provider, a jewelry store, an automobile manufacturer, cash, a travel agency, a hotel chain, an airline, employee benefits, company stock or bonds, or the like. Further, the user may apportion part of a balance to one category, and other parts of the balance to other categories. Each of the parts may have different redemption values based on the percentage allocated and the bid premium associated with the respective redemption category. In some cases, a portion of a balance that is not otherwise allocated can be directed automatically to a default redemption category. In one particular instance, the default redemption category is cash.

Other embodiments of the present invention provide methods for allocating and redeeming elective account balances. The methods include providing a first interface to a bid device across a communication network, and receiving a bid premium via the first interface. In addition, a second interface is provided to a redemption device, and a percentage of an elective balance associated with a redemption category is received there from. A redemption amount is calculated through multiplying the elective balance by the percentage of the elective balance and the bid premium.

Yet other embodiments of the present invention provide methods for allocating and redeeming elective account balances that include providing an identification interface to a redemption device across a communication network. Identification information indicating a particular elective account is received, and a balance associated with the elective account is accessed. An account interface including the balance is provided to the redemption device via the communication network, and an allocation selection is received from the redemption device. The allocation amount indicates an amount of the balance to be associated with a redemption category.

The summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the Figures which are described in remaining portions of the specification. In the Figures, like reference numerals are used throughout several Figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a servicing engine in accordance with embodiments of the present invention;

FIG. 2 is a diagram of a bid and allocation system in accordance with various embodiments of the present invention;

FIG. 3 is an exemplary data segment in accordance with some embodiments of the present invention;

FIG. 4 is an exemplary bid interface in accordance with an embodiment of the present invention;

FIG. 5 is an exemplary redemption/account interface in accordance with an embodiment of the present invention;

FIG. 6 is a flow diagram illustrating a method in accordance with an embodiment of the present invention; and

FIG. 7 depicts another system in accordance with some embodiments of the present invention.

### DETAILED DESCRIPTION OF THE INVENTION

Among other things, the present invention provides mechanisms for selecting a method, form, and/or amount to distribute from an account balance. The account balance can be associated with an elective account that, for the purposes of this document, can be any account with a balance (e.g., some value) that can be distributed upon election of the account holder. As one example, an elective account can be an employee incentive account that is augmented by an employer, and distributed to an employee, or a beneficiary of the employee. The form in which the balance is distributed can be, but is not limited to, a stored value card, a cash amount, a negotiable instrument such as a check or money order, stock, certificates exchangeable for merchandise or services, employee benefits such as additional vacation or sick days, and the like. Once the form is selected, the amount of the redemption can be deducted from the account balance, and the redemption can be provided to the account holder or other beneficiary in the selected form, and according to a distribution method. The distribution methods can include, but are not limited to, physical delivery, electronic exchange, or the like. Thus, for example a stored value card can be mailed to a recipient, a piece of merchandise can be delivered to a recipient, a cash amount can be applied electronically to a bank account of the recipient, and the like. Alternatively, or in addition, an identification, such as an employee identification number can be linked to a virtual or physical gift card number.

Some versions of the present invention also provide for granting premiums based on a selected redemption category. For the purposes of this document, a redemption category is any category of value to which the balance of an elective account (e.g., an elective balance) can be maintained, or converted. Thus, for example, a redemption category can be cash, an amount exchangeable at a particular retailer or group of retailers, products available from a retailer or group of retailers, an amount exchangeable at a particular service provider or group of service providers, a benefit offered by an employer, a charitable organization, a negotiable instrument, or the like.

In some embodiments of the present invention, various entities associated with one or more redemption categories vie for the elective balances maintained by the account holders. This can include offering premiums that can be, for example, more than one hundred percent of an account balance, where the account balance is redeemed for a stored value card or negotiable certificate associated with the particular retailer. These premiums are referred to herein as bid premiums, and represent an amount above or below the par value for an account balance. Thus, for example, one retailer may offer a bid premium of 1.1, or one hundred, ten percent of the value maintained in an account if exchanged for a stored value card that is redeemable by the retailer. Alternatively, an employer may offer a bid premium of 0.9, or ninety percent of the value maintained in an account where the value will be exchanged for additional vacation days. Based on this disclosure, one of ordinary skill in the art will recognize a number of other bid premiums that can be offered in relation to a variety of redemption categories.

In some embodiments of the present invention, each of the entities associated with redemption categories can see the bid premiums, and/or the category requirements being offered by other entities. Thus, an entity can be provided with information that aids its decision on whether to increase or decrease bid premiums and/or modify requirements associated with its redemption categories. Thus, particular aspects of the present invention provide an auction like market useful to capture balances associated with elective accounts.

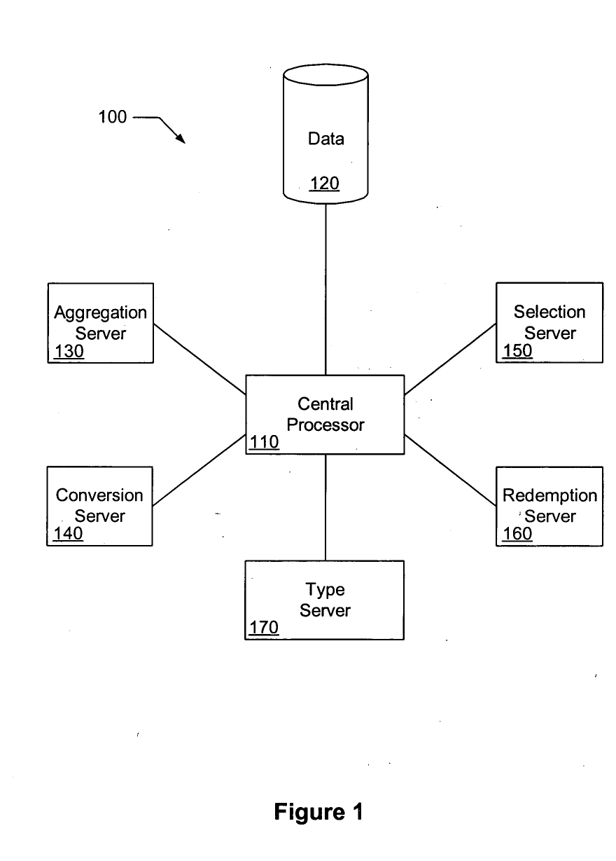

Referring to FIG. 1, a block diagram of a servicing engine 100 in accordance with embodiments of the present invention is depicted. Servicing engine 100 includes a central processing unit 110 that can access one or more of a computer readable medium 120, an aggregation server 130, a conversion server 140, a selection server 150, a redemption server 160, and a type server 170. Central processor 110 can be a single microprocessor based device, or a group of two or more microprocessor based devices. As one example, central processor 110 can be a personal computer (PC), and the various servers 130, 140, 150, 160, 170 can be implemented in software on the PC. As another example, each of the servers 130, 140, 150, 160, 170 can be a separate computer responsible for performing particular tasks. In such a case, central processor 110 can include each of the processors associated with the severs. Based on this disclosure, one of ordinary skill in the art will appreciate the myriad of configurations the central processor 110 can assume in accordance with the present invention.

Computer readable medium 120 can be any computer readable medium capable of maintaining computer executable instructions and data. Such instructions can be related to any of central processor 110, aggregation server 130, conversion server 140, selection server 150, redemption server 160, and type server 170. Further, computer readable medium 120 can be a combination of computer readable media. Thus, in one particular embodiment of the present invention, central processor 110 can include a Random Access Memory (RAM), one or more hard disk drives, and one or more removable storage elements that together comprise computer readable medium 120. Based on this disclosure, one of ordinary skill in the art will appreciate the variety of computer readable media useful for implementing computer readable medium 120.

Aggregation server 130 is responsible for aggregating selection, redemption, and conversion information in relation to one or more elective accounts. Thus, aggregation server 130 can include processes for receiving information from the various servers 140, 150, 160, 170, calculating elective account balances, updating a database of elective account information, and the like. Calculation of such information is discussed in more detail below. As previously suggested, aggregation server 130 can be implemented in software on a PC, or other microprocessor based device that includes central processor 110. Alternatively, aggregation server 130 can be implemented on a separate microprocessor based device, or on a microprocessor based device where a subset of the various servers 140, 150, 160, 170 is implemented. Based on this disclosure, one of ordinary skill in the art will recognize a number of configurations in which aggregation server 130 can be implemented.

Conversion server 140 is responsible for converting percentages of an elective balance provided by selection server 150 into redemption amounts associated with redemption categories, based on bid premium information provided by type server 170. Thus, conversion server 140 can include processes for receiving information from the various servers 130, 150, 160, 170, and for performing various calculations. Calculating redemption amounts is discussed in more detail below. As previously suggested, conversion server 140 can be implemented in software on a PC, or other microprocessor based device that includes central processor 110. Alternatively, conversion server 140 can be implemented on a separate microprocessor based device, or on a microprocessor based device where a subset of the various servers 130, 150, 160, 170 is implemented. Based on this disclosure, one of ordinary skill in the art will recognize a number of configurations in which conversion server 140 can be implemented.

Selection server 150 is responsible for receiving allocation information from an account holder indicating amounts of an elective balance to be apportioned to a particular redemption category. Thus, selection server 150 can include processes for serving an account, identification, and/or selection interface, and for receiving information via such interfaces. Such interfaces are discussed below in greater detail. As previously suggested, selection server 150 can be implemented in software on a PC, or other microprocessor based device that includes central processor 110. Alternatively, selection server 150 can be implemented on a separate microprocessor based device, or on a microprocessor based device where a subset of the various servers 130, 140, 160, 170 is implemented. Based on this disclosure, one of ordinary skill in the art will recognize a number of configurations in which selection server 150 can be implemented.

Redemption server 160 is responsible for receiving redemption information from an account holder indicating amounts to be redeemed in association with particular redemption categories. Thus, redemption server 160 can include processes for serving an account, identification, and/or selection interface in conjunction with conversion server 150, and for receiving information via such interfaces. As previously suggested, redemption server 160 can be implemented in software on a PC, or other microprocessor based device that includes central processor 110. Alternatively, redemption server 160 can be implemented on a separate microprocessor based device, or on a microprocessor based device where a subset of the various servers 130, 140, 150, 170 is implemented. Based on this disclosure, one of ordinary skill in the art will recognize a number of configurations in which redemption server 160 can be implemented.

Type server 170 is responsible for maintaining an indication of the various redemption categories that can be selected in relation to elective accounts. Thus, type server 170 can include processes for enrolling entities, and providing information to entities that are associated with redemption categories. Further, in embodiments where bid premiums are utilized, type server 170 can be responsible for serving bid interfaces and identification interfaces, and for receiving and maintaining bid premium information in relation to the redemption categories. As previously suggested, type server 170 can be implemented in software on a PC, or other microprocessor based device that includes central processor 110. Alternatively, type server 170 can be implemented on a separate microprocessor based device, or on a microprocessor based device where a subset of the various servers 130, 140, 150, 160 is implemented. Based on this disclosure, one of ordinary skill in the art will recognize a number of configurations in which type server 170 can be implemented.

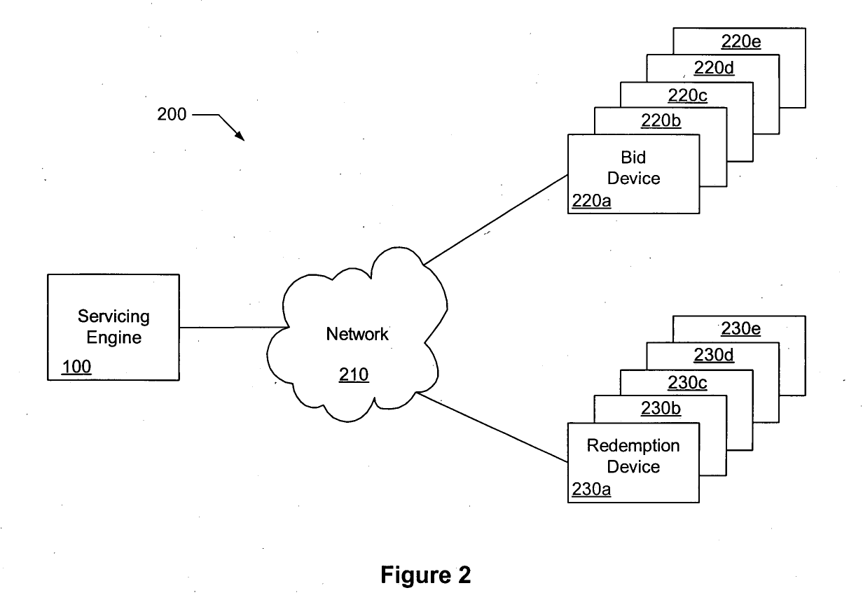

Turning now to FIG. 2, a system 200 including servicing engine 100 is depicted. System 200 includes servicing engine 100 communicably coupled to one or more bid devices 220, and one or more redemption devices 230 via a communication network 210. Communication network 210 can be any communication network capable of providing communications between the various elements of system 200. In some embodiments, communication network 210 is the Internet providing message based communication between bid devices 220 and servicing engine 100, and between redemption devices 230 and servicing engine 100. In other embodiments, communication network 210 comprises a TCP/IP compliant virtual private network (VPN). In yet other embodiments, communication network 210 includes the Internet for communication between bid devices 220 and servicing engine 100, and a VPN between redemption devices 230 and servicing engine 100. However, it should be recognized that other communication networks could be used to provide similar functionality. For example, communication network 210 can be a local area network (LAN), a wide area network (WAN), a telephone network, a cellular telephone network, a virtual private network (VPN), the Internet, an optical network, a wireless network, or any other similar communication network or combination thereof.

A bid device 220 can be any device capable of communicating bid premium information to and/or from servicing engine 100 and an entity associated with one or more redemption categories. In one particular embodiment, bid device 220 is a PC with an Internet browser that is operated by a retail entity. Based on this disclosure, one of ordinary skill in the art will recognize a variety of other bid device(s) useful in relation to the present invention. A redemption device 230 can be any device capable of communicating allocation and/or redemption information to and/or from servicing engine 100 and an elective account holder. In addition, redemption device 230 can be responsible for communicating information about the form of a redeemed instrument and the method for delivering the selected form. In one particular embodiment, redemption device 230 is a PC with an Internet browser, and operated by an account holder. Based on this disclosure, one of ordinary skill in the art will recognize a variety of other redemption device(s) useful in relation to the present invention.

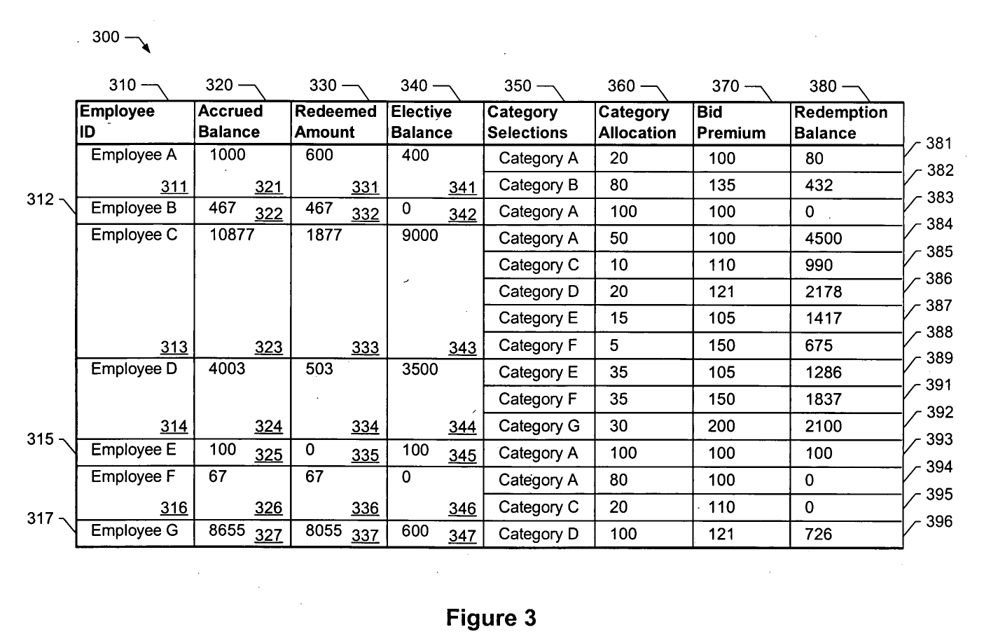

Turning now to FIG. 3, an exemplary data segment 300 in accordance with some embodiments of the present invention is depicted. Data segment 300 includes an arrangement that facilitates the conceptual understanding of the present invention. It should, however, be recognized that many data organizations existing on different databases are possible in accordance with the present invention. Data segment 300 includes information associated with a number of account holders 310, designated here as employees 311-317. The associated information includes accrued balances 320 designated as balances 321-327, redeemed amounts 330 designated as amounts 331-337, elective balances 340 designated as elective balances 341-347, redemption categories 350, category allocations 360, bid premiums 370, and redemption values 380.

In some embodiments of the present invention, accrued balance 320 is augmented by the employer, or another entity associated with the employee. This can be done to reward an employee for service. A part or all of accrued balance 320, designated as redeemed amount 330, may have been previously redeemed by the employee or a beneficiary thereof. The remaining, unredeemed portion of accrued balance 320 is elective balance 340. Various redemption categories 350 can be chosen to receive elective balance 340 in an amount defined by a category allocation 360. In addition, elective balance 340, subject to category allocation 360, is multiplied by bid premium 370 to arrive at redemption value 380 for the category.

Thus, using employee A 311 for illustration, redeemed amount 341 of six hundred is deducted from accrued balance 321 of one-thousand to get elective balance 341 of four hundred. These amounts can be in U.S. Dollars, or some other unit of measurement. Employee A has chosen to have elective balance 341 divided between redemption category A (line 381) and redemption category B (line 382), in category allocations 360 of twenty percent (line 381) and eighty percent (line 382), respectively. In addition, the entity associated with redemption category A (line 381) has chosen a bid premium 370 of one hundred percent (line 381), and the entity associated with redemption category B (line 382) has chosen a bid premium 370 of one hundred, thirty-five percent (line 382). Thus, employee A 311 has a redemption balance 380 of four hundred, multiplied by twenty percent and one hundred percent, or eighty (line 381). In addition, employee A 311 has a second redemption balance 380 of four hundred, multiplied by eighty percent and one hundred, thirty-five percent, or four hundred, thirty-two (line 382). This same process can be repeated for each of employees 312-317 using the accrued balances 320, redeemed amounts 330, elective balances 340, redemption categories 350, category allocations 360, and bid premiums 370 as illustrated.

The information illustrated in FIG. 3 can be obtained in a number of ways. For example, an employer may provide information about an employee's performance, to which a benefit calculation is applied, and in turn, a resulting amount is added to the accrued balance for the particular employee. Alternatively, an employee may be given a yearly amount to apply in a manner that they see fit. As yet another alternative, an employee may be given an option to deduct a periodic amount from their paycheck that is in turn applied to the accrued balance.

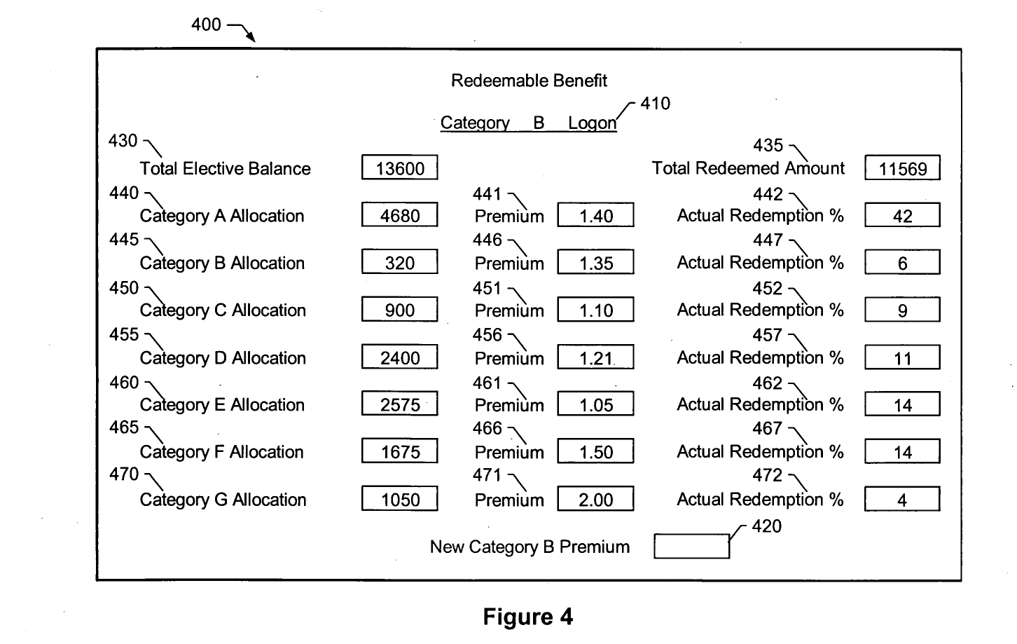

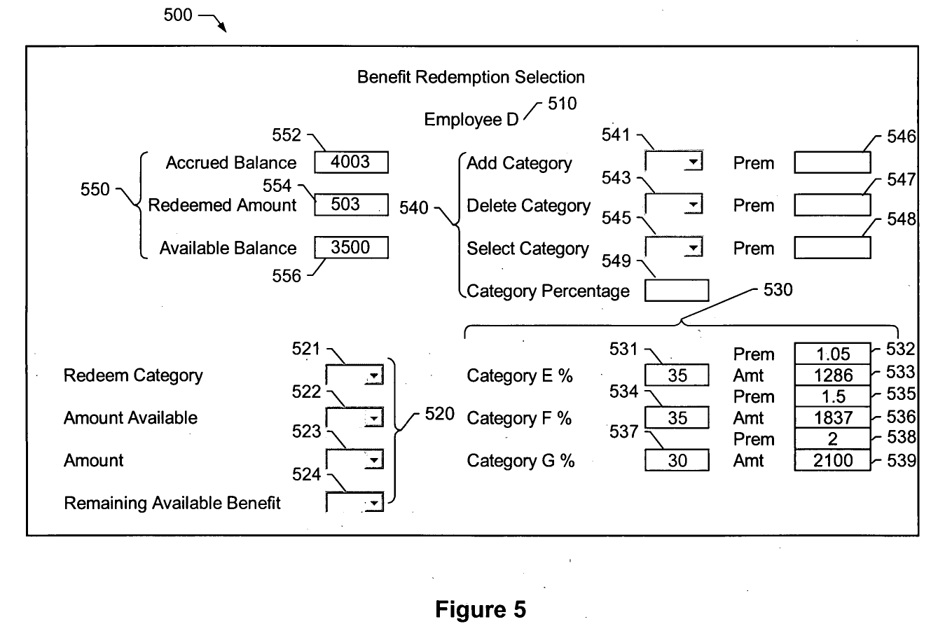

The employee can request a redemption via an interactive voice response (IVR) system, one or more Internet pages, or the like. Further, an entity can apply to offer a redemption category, monitor the bid premiums being offered in relation to other redemption categories, or modify bid premiums associated with redemption categories offered by the entity. This can be done via an IVR system, one or more Internet pages, or the like. FIGS. 4 and 5 illustrate two such interfaces, and based on the disclosure provided herein, one of ordinary skill in the art will recognize a number of other interfaces and/or enhancements that can be added to the presented interfaces.

Turning to FIG. 4, an interface 400 is depicted and includes bid premium information associated with various redemption categories, and a place to update a bid premium associated with the accessing entity. Interface 400 may be accessed by first accessing an identification and/or enrollment interface. As is known in the art, such interfaces can be tailored to request an identification of the entity and a password, or various enrollment information. From this information, the accessing entity can be authorized to access interface 400.

Interface 400 includes an indication of the accessing entity 410. This is particularly useful where an entity is associated with various different redemption categories, and accesses interface 400 as a different entity for each redemption category. As illustrated, the entity associated with redemption category B is accessing interface 400. In addition, interface 400 includes a total available balance field 430 that indicates the total amount of elective balances 340 for an employer or sponsoring entity. Thus, for example, using the numbers from data segment 300, the total elective balance is 430 is thirteen thousand, six hundred. The total elective balance 430 represents the pool of value bid upon by the competing entities associated with the various redemption categories. Thus, an entity may seek to secure more of the pool by increasing the bid premium offered in relation to a redemption category associated with the entity, or to decrease its percentage of the pool by reducing the bid premium.

In addition, interface 400 includes a list of amounts 440, 445, 450, 455, 460, 465, 470 allocated from total elective balances 430 to the various redemption categories. In addition, bid premiums 441, 446, 451, 456, 461, 466, 471 offered by the entities associated with the respective redemption categories are provided as part of interface 400. For example, redemption category A offers a bid premium of one hundred percent, and has been allocated four thousand, six hundred and eighty of the total elective balance 430 of thirteen thousand, six hundred. In contrast, redemption category B is allocated three hundred, twenty of the total elective balance 430, while the entity associated therewith is offering a one hundred, thirty-five percent bid premium. An entity desiring to capture more or less of total elective balance 430 can utilize such comparison information to determine an effective level at which to set its bid premium(s). Thus, interface 400 provides an open market in which various entities can compete for access to total elective balance 430 through modification of its bid premium(s). Where an entity desires to modify its bid premium, the entity can provide the new bid premium information in selection box 420. This information is then transmitted to servicing engine 100, and subsequently provided in relation to the redemption category associated with the entity. Thus, the updated bid premium information can be viewed by all entities accessing servicing engine 100 via interface 400.

Interface 400 can also include historical redemption information in addition to the prospective redemption information previously described. Such historical redemption information can include a total redeemed amount 435, which using data segment 300 as an example, is eleven thousand, five hundred, sixty-nine. The percentage of total redeemed amount 435 that was redeemed in each of the redemption categories is listed in actual redemption percentage fields 442, 447, 452, 457, 462, 467, 472, respectively. This actual redemption percentage information represents the proportion of total redeemed amount 435 that was actually redeemed for goods, services, or benefits provided in relation to the respective redemption category. This provides entities with additional information that can be used to determine bid premiums. Based on the disclosure provided herein, one of ordinary skill in the art will recognize other information that can be provided to entities, and thereby create a competitive market for securing total elective balance 430. For example, an effective bid premium, or the average bid premium offered in relation to each of the actual redemption percentages may also be provided.

Further, based on the disclosure provided herein, one of ordinary skill in the art will recognize a number of other interfaces that can be used in relation to entities associated with redemption categories. For example, one interface may be an enrollment interface that can be tailored to gather information about an enrolling entity, and to provide information to an enrolling entity about the bid premium process. Such an interface could automate the acceptance of offering entities into the system.

Turning to FIG. 5, an account and redemption interface 500 is illustrated. Account and redemption interface 500 is typically served to an account holder after the account holder has been identified and/or authorized to access servicing engine 100 using methods known in the art. Such methods can include, for example, providing a logon interface to an account holder, and receiving an account number and a password from the account holder.

Account and redemption interface 500 includes an identification 510 of the accessing account holder. Further, account and redemption interface 500 includes an account summary section 550 with an accrued balance 552, a redeemed amount 554, and an available balance 556 specific to the account holder. As will be appreciated, this information can be gathered from a database, such as that represented by data segment 300. Thus, for example, where the account holder that has accessed interface 500 is employee D 314, the information from data segment 300 associated with employee D 314 can be used to update interface 500.

Interface 500 includes a redemption category allocation section 530. For each selected redemption category, a percentage allocated to the category, a bid premium associated with the redemption category, and a redemption amount associated with that category are included. Thus, using employee D 314 as an example, redemption category E has been selected with an allocation percentage 531 of thirty-five. This allocation percentage can be combined with a current bid premium 532 of one hundred, five percent to derive a redemption amount 533 of one thousand, two hundred, eighty-six. This redemption amount is calculated as previously described in relation to data segment 300 above. Where bid premium 532 is updated by the entity associated with redemption category E, it is updated on interface 500 and the associated redemption amount 533 is recalculated. Similarly, redemption category F and redemption category G with the associated allocation percentages 534, 537, bid premiums 535, 538, and redemption amounts 536, 539 are provided and updated.

Interface 500 includes a modification section 540 that includes an add a redemption category 541, a delete a redemption category 543, a select a redemption category 545, and a redemption category percentage 549 input box. Add a redemption category 541 provides a selector box where a redemption category can be chosen that is not currently included in the allocation. When an additional redemption category is selected, the bid premium associated with the selected redemption category is displayed in premium box 546. Once the redemption category is added, the percentage of available balance 556 is written to category percentage input box 549. Once done, the selected redemption category is added at the defined percentage. This information is then updated in redemption category allocation percentage section 530. In some embodiments, the percentages of the previously selected redemption categories are changed on a prorated basis. Alternatively, the newly allocated percentage may be taken from a default redemption category, such as, for example, a cash category.

Delete a redemption category 543 provides a selector box where a redemption category that is currently included in the allocation can be removed from the allocation. When a redemption category is selected for deletion, the bid premium associated with the selected redemption category is displayed in premium box 547. Upon selection, the selected redemption category is removed from redemption category allocation percentage section 530. In some embodiments, the percentages of the previously selected redemption categories are changed on a prorated basis to include the percentage previously allocated to the deleted redemption category. Alternatively, the percentage from the deleted category can be applied to a default redemption category, such as, for example, a cash category.

Select a redemption category 545 provides a selector box where a redemption category that is currently included in the allocation can be selected, and a modified allocation percentage to be applied to the selected redemption category can be input to redemption category percentage input box 549. The modified percentage amount is then reported in redemption category allocation percentage section 530. In some embodiments, the percentages of the previously selected redemption categories are changed on a prorated basis to include the percentage previously allocated to the deleted redemption category. Alternatively, the percentage modification is adjusted to/from a default redemption category, such as, for example, a cash category.

In addition, interface 500 includes a redemption section 520 that includes a redemption category selector 521, an amount available 522, an amount to be redeemed 523, and a remaining available balance 524. When an account holder selects a redemption category from which to obtain a redemption, the redemption amount from redemption category allocation percentage section 530 associated with that category is displayed in amount available 522. The user can then place a desired redemption amount in amount to be redeemed 523. This amount to be redeemed 523 is deducted from the amount available 522, and the result displayed in the remaining available balance amount 524. Once the redemption selection is completed, the selected redemption is completed, and the redeemed amount is added to redeemed amount 554, and the available amount 556 is recalculated.

Based on the disclosure provided herein, one of ordinary skill in the art will recognize a number of other interfaces that can be provided in relation to the present invention. For example, one or more interfaces can be provided that include information about processes for redeeming, limitations associated with any such redemptions, methods for having a redemption provided, and the like. As another example, an interface for indicating the form in which a redemption is requested, or an address at which to deliver a requested redemption is possible.

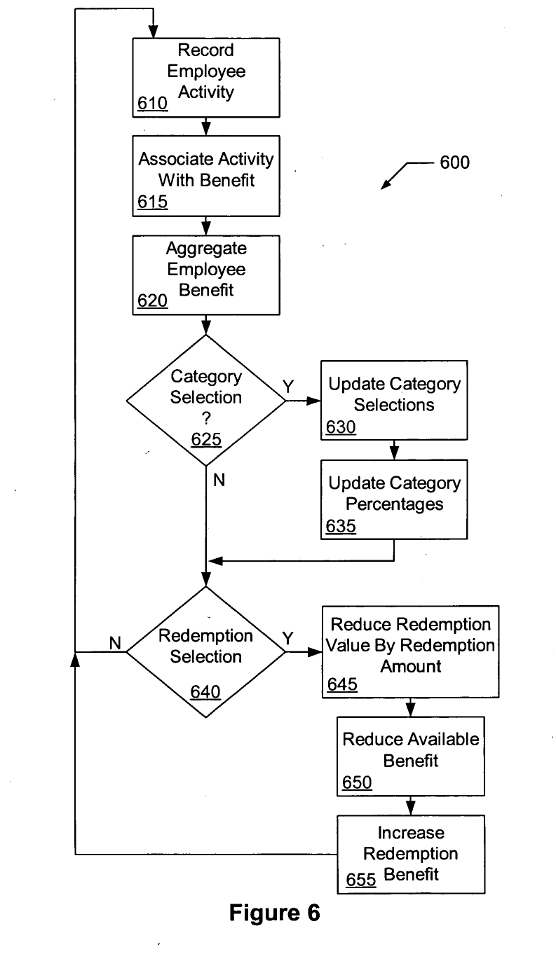

Turning to FIG. 6, a flow diagram 600 illustrating a method of the present invention is disclosed. Following flow diagram 600, employee activity is recorded by an employer (block 610). This information can include years of service, number of hours logged in a time period, outstanding achievements, and the like. This information can then be used to calculate a benefit to be associated with the activity (block 615). For example, where the number of hours logged in a given time period exceeds a predetermined number, an amount can be provided to recognize this achievement. This amount is added to the accrued amount maintained in relation to the employee's account (block 620).

In addition, it is determined whether the employee has accessed an interface and has modified the redemption categories (block 625). It can also be determined if the employee has requested a redemption (block 640). Where neither of these has occurred, the process of monitoring the employee activity and providing a benefit in relation to the monitored activity is continued.

Where a category selection has occurred (block 625), the category selections (block 630) and the category allocations (block 635) are updated using information provided via one or more interfaces. This can include updating each selected category with information provided via the interface(s), or updating one category with information provided via the interface(s) and updating other categories based on some predetermined formula. Such a predetermined formula can include, but is not limited to, making all changes to allocations from amounts maintained in relation to default category(s), or prorating all changes across unselected categories. This updated information is then made available to entities associated with the redemption categories by, for example, a bid premium interface, and to the employee by, for example, an account interface.

Where a redemption selection has occurred (block 640), the redemption value associated with the redemption category is reduced by the amount redeemed (block 645), the elective balance is deducted by a corresponding amount (block 650), and the redeemed amount is increased by the corresponding amount (block 655). This updated information can then be reflected on a bid premium interface indicating actual redemptions, and on the employees account interface. The selected redemption can then be processed and provided to the employee in a prescribed manner. Thus, for example, the employee may receive a stored value card indicated by the selected redemption category, and in the chosen amount. As an alternate example, the employee may receive a cash sum associated with the selected redemption category deposited directly into the employee's checking account. As yet another example, the employee may be given an amount of the employer's stock delivered to the employee's brokerage account. Based on the disclosure provided herein, one of ordinary skill in the art will recognize a number of methods that can be used to distribute redemptions. Further, one of ordinary skill in the art will recognize a number of redemption categories and forms that the redemptions can take.

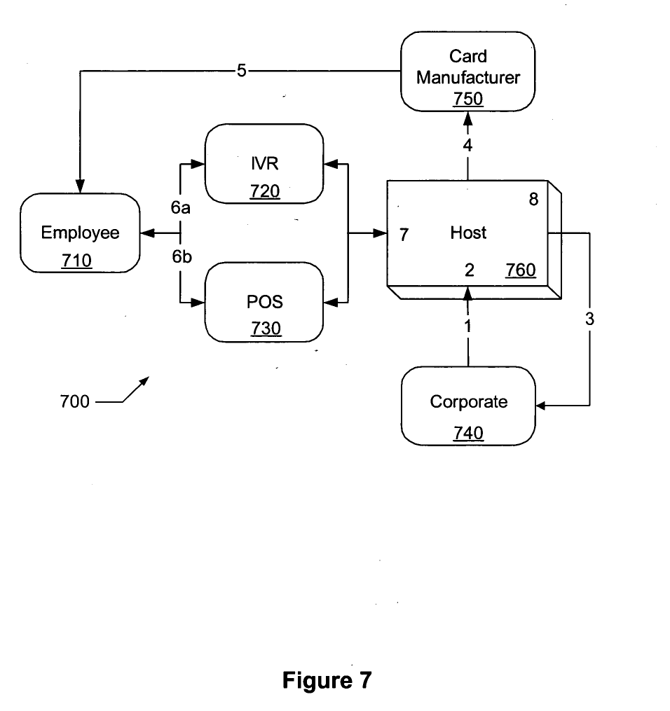

Turning now to FIG. 7, another system 700 in accordance with some embodiments of the present invention is illustrated. System 700 includes a host computer 760 that can be any computer including, for example, a mainframe computer. In operation, a corporate entity 740 sends a batch file with activations (e.g., creating a new account), reloads (e.g., adding value or deducting value from an existing account), and deactivations (e.g., closing an existing account) to host computer 760. Host computer 760 links an employee identification of an employee associated with corporate entity 740 to a card account number and processes one or more activations, reloads, and/or deactivations associated with the account. Where an error occurs, host computer 760 sends an error report to corporate entity 740 for review. Where a card is to be printed in relation to the account, host computer 740 sends a card file to a card manufacturer 750, and card manufacturer 750 creates the card to be associated with the account and provides the card to an employee 710 related to the account. Employee 710 can then perform various transactions including redemptions and balance inquiries through either or both of a point of sale (POS) device 730 or a automated voice response (IVR) system 720. Such employee access systems can be maintained by corporate entity 740, or another entitiy. The IVR and POS transactions are transmitted to host computer 760 where they are processed. In some cases, zero balance cards are automatically deactivated.

In some cases, system 700 can be used to load periodic values on a stored value card, while in other cases, the values loaded can be based on milestones being achieved. Activations and/or reloads can be provided via an off-line, or back office batch process. In some cases, such activities are not allowed via a POS system. Further, in some cases, deactivation can be done base on a dormancy period exceeding a set length in time and/or the termination of the employee.

The invention has now been described in detail for purposes of clarity and understanding. However, it will be appreciated that certain changes and modifications may be practiced within the scope of the appended claims. For example, the present invention have been discussed in relation to an employer/employee incentive relationship, however, many other kinds of incentive accounts and incentive relationships can exist. Further, the present invention can be applied in a consumer union organization where a number of consumers input funds to accounts, and a number of retailers are allowed to bid on access to those funds through the bid premium process disclosed herein. Accordingly, it should be recognized that many other systems, functions, methods, and combinations thereof are possible in accordance with the present invention. Thus, although the invention is described with reference to specific embodiments and Figures thereof, the embodiments and Figures are merely illustrative, and not limiting of the invention. Rather, the scope of the invention is to be determined solely by the appended claims.

What is claimed is:

1. A system for distributing elective account balances, the system comprising:
a microprocessor based device communicably coupled to a communication network;
a computer readable medium associated with the microprocessor based device, wherein the computer readable medium includes instructions executable by the microprocessor based device to:
receive a request for a first interface from a bid device;
serve the first interface to the bid device across the computer network, wherein the first interface is operable to receive a first input;
receive a request for a second interface from a redemption device;
serve the second interface to the redemption device across the computer network, wherein the second interface is operable to receive a second input;
allocate at least a portion of an elective balance to a redemption category based at least in part on the second input; and
calculate a redemption amount by multiplying the portion of the elective balance by the first input.

2. The system of claim 1, wherein the first input is a bid premium.

3. The system of claim 1, wherein the instructions executable by the microprocessor based device are further executable to:
receive a request for a third interface;
serve the third interface to the redemption device, wherein the third interface is operable to receive a third input; and
deduct an amount corresponding to the third input from the redemption amount, and reduce the elective balance by an amount corresponding to the third input divided by the first input.

4. The system of claim 1, wherein the redemption category is selected from a group consisting of: cash, a retail outlet, vacation time, additional sick days, and a service provider.

5. The system of claim 1, wherein the redemption category is a first redemption category, wherein the portion of the elective balance is a first portion of the elective balance, wherein the redemption amount is a first redemption amount, wherein the second interface is further operable to receive a fourth input, wherein the bid device is a first bid device, and wherein the instructions executable by the microprocessor based device are further executable to:
receive a request for a third interface from a second bid device;
serve the third interface to the second bid device across the computer network, wherein the third interface is operable to receive a third input;
allocate a second portion of the elective balance to a second redemption category based at least in part on the fourth input; and
calculate a second redemption amount by multiplying the second portion of the elective balance by the third input.

6. The system of claim 1, wherein the redemption category is a first redemption category, and wherein the instructions executable by the microprocessor based device are further executable to:
allocate a remaining portion of the elective balance to a second redemption category.

7. The system of claim 6, wherein the first redemption category is selected from a group consisting of: a retail outlet, vacation time, additional sick days, and a service provider.

8. The system of claim 7, wherein the second redemption category is cash.

9. A method for allocating and redeeming elective account balances, the method comprising:
providing a first interface to a bid device across a communication network;
receiving a bid premium via the first interface;
providing a second interface to a redemption device;
receiving a percentage of an elective balance via the second interface, wherein the percentage of the elective balance is associated with a redemption category; and
calculating a redemption amount by multiplying the elective balance by the percentage of the elective balance and the bid premium.

10. The method of claim 9, wherein the redemption category is a first redemption category, wherein the percentage of the elective balance is a first percentage of the elective balance, wherein the bid device is a first bid device, wherein the bid premium is a first bid premium, the method further comprising:
providing a third interface to a second bid device across the communication network;
receiving a second bid premium from the second bid device, wherein the second bid premium is associated with a second redemption category; and
receiving a second percentage of the elective balance from the redemption device, wherein the second percentage of the elective balance is associated with the second redemption category.

11. The method of claim 10, wherein the redemption amount is a first redemption amount, the method further comprising:
calculating a second redemption amount by multiplying the elective balance by the second percentage of the elective balance and the second bid premium.

12. The method of claim 9, the method further comprising:
allocating a remaining portion of the elective balance to cash.

13. The method of claim 9, wherein the redemption category is selected from a group consisting of: cash, a retail outlet, vacation time, additional sick days, and a service provider.

14. A method for allocating and redeeming elective account balances, the method comprising:
providing an identification interface to a redemption device across a communication network;
receiving an identification via the identification interface, wherein the identification indicates an elective account;
accessing a balance associated with the elective account;
providing an account interface including the balance to the redemption device via the communication network; and
receiving an allocation selection from the redemption device, wherein the allocation selection indicates an amount of the balance to be associated with a redemption category.

15. The method of claim 14, the method further comprising:
associating the amount of the balance with the redemption category; and
updating the account interface to indicate the amount of the balance associated with the redemption category.

16. The method of claim 15, wherein the redemption category is selected from a group consisting of: cash, a retail outlet, vacation time, additional sick days, and a service provider.

17. The method of claim 15, the method further comprising:
allocating a remaining portion of the balance to cash; and
wherein the redemption category is selected from a group consisting of: a retail outlet, vacation time, additional sick days, and a service provider.

18. The method of claim 14, the method further comprising:
providing a bid premium interface to a bid device via the communication network;
receiving a bid premium from the bid device, wherein the bid premium is associated with the redemption category; and
calculating the redemption amount based at least in part on the bid premium.

19. The method of claim 18, wherein the amount of the balance is a percentage of the balance, and wherein calculating the redemption amount comprises:
multiplying the balance by the percentage of the balance and the bid premium.

20. The method of claim 18, wherein the redemption category is a first redemption category, wherein the amount of the balance is a first amount of the balance, wherein the bid premium interface is a first bid premium interface, wherein the bid premium is a first bid premium, wherein the bid device is a first bid device, and wherein the account allocation is a first account allocation, the method further comprising:
providing a second bid premium interface to a second bid device via the communication network;
receiving a second bid premium from the second bid device, wherein the second bid premium is associated with a second redemption category; and
receiving a second allocation selection from the redemption device, wherein the second allocation selection indicates a second amount of the balance to be associated with the second redemption category.

21. The method of claim 20, wherein the redemption amount is a first redemption amount, the method further comprising:
calculating a second redemption amount based at least in part on the balance, the second bid premium, and the second allocation selection.
